(19) United States
(12) Patent Application Publication
(10) Pub. No.: US 2026/0172460 A1
(43) Pub. Date: Jun. 18, 2026

(54) Methods for assisting in sharing a multimedia element and for reporting a perception, and corresponding electronic devices, system, computer program products and media

(71) Applicant: ORANGE, Issy-les-Moulineaux (FR)

(72) Inventors: Jean-François LETELLIER, CHATILLON (FR); Julien FAURE, CHATILLON (FR); Frank MEYER, CHATILLON (FR)

(21) Appl. No.: 19/422,587

(22) Filed: Dec. 17, 2025

(30) Foreign Application Priority Data
Dec. 18, 2024 (FR) FR2414529

(51) Int. Cl. H04L 65/611; H04L 65/75

(52) U.S. Cl. CPC H04L 65/611; H04L 65/75

(57) ABSTRACT

An assistance method, a reporting method, corresponding electronic devices, computer program products and media. The assistance method includes: obtaining a multimedia element to be shared by a first user of a first electronic device with at least two second users of second electronic devices, which are distinct from the first user; providing the first user with information representative of a perception of a portion of the multimedia element by the second users, the representative information being information that does not allow the second users to be distinguished from one another. The reporting method is out by a second device and includes providing the first electronic device with an indication of perception of a portion of the multimedia element by a second user of the second device, the indication being obtained automatically by the second device.

### 1. CROSS REFERENCE TO RELATED APPLICATIONS

The present application claims priority to and the benefit of French Patent application FR2414529, filed Dec. 18, 2024, the entire content of which is incorporated herein by reference.

### 2. TECHNICAL FIELD

The present application relates to the field of telecommunications and more precisely to the field of information sharing between users of at least one electronic device. It relates in particular to a sharing assistance method and a perception reporting method, each carried out by one or more electronic devices, and to the corresponding electronic devices, computer program products and storage media.

### 3. PRIOR ART

The use of electronic means for sharing information between individuals is increasingly widespread. The information shared may be diverse. For example, it may be audio (for example voice), textual or graphical information, or a combination of at least two of these types of information. Thus, the sharing can concern a textual or graphical medium, supplemented by audio comments (from a presenter of this medium in particular).

Perception of the information shared in these communications can vary among individuals, which can affect the quality of the communication.

The purpose of the present application is to propose improvements for at least some of the disadvantages of the prior art.

### 4. SUMMARY

A non-limiting exemplary aspect of the present application improves the situation by means of a method for assisting in sharing a multimedia element, said method comprising:
obtaining at least part of a multimedia element intended to be shared by a first user of a first electronic device with at least two second users of second electronic devices, said second users being distinct from said first user;
providing said first user with at least one piece of information representative of a perception of one or more portions of said multimedia element by at least one of said second users.

In some embodiments, said representative information may, for example, be information that does not allow said second users to be distinguished from one another. In some embodiments, said representative information may, for example, be anonymized information.

Depending on the embodiments, the sharing may be synchronous (for example during a teleconference) or asynchronous (by e-mail, or by means of storage in a shared space). The multimedia element may be an audio, textual, image or video element, or a combination of such elements.

The first device may, for example, be a terminal, a gateway or a server.

It should be noted that the method can be carried out in embodiments in which the first and/or second users use (for example at different times) the same device (the terms “first device” and/or “second devices” then designating the same device). The multimedia element, in such embodiments, may, for example, be a multimedia element that has been made available by the first user in a storage space of the device and allows write access by the first user and read access by the second users.

In at least some embodiments, said method comprises providing said first user with a designation of said portion of said multimedia element.

In at least some embodiments, said representative information takes into account said at least one second user's knowledge of at least one audiovisual item present in said portion of said multimedia element.

In at least some embodiments, said representative information takes into account at least one indication of perception received from at least one of said second devices via a communication interface of said first device.

In at least some embodiments, said providing of said representative information is carried out prior to said multimedia element being shared between said first device and said second devices.

Such embodiments may, for example, provide assistance for creating (constructing) a multimedia element when the first user is the creator of the multimedia element and already knows, at the time of the multimedia element being created, which “second” users (inter alia) this multimedia element is intended for.

In at least some embodiments, said providing of said representative information is carried out when said multimedia element is synchronously shared by said first and second devices, prior to and/or at the time of said portion of said multimedia element being rendered. Embodiments in which the information representative of perception is provided just before or when that portion of said multimedia element to which it relates is rendered may, for example, help the first user (sharing the multimedia element) to support this sharing with personalized explanations, taking this representative information into account. For example, such embodiments can help a first user, the presenter of a slideshow-type multimedia element, to adapt an oral presentation of the relevant portion of the multimedia element

according to the representative information with which they have been provided (for example by providing more detailed explanations or conversely by limiting their explanations when the relevant portion is presented). Embodiments in which the information representative of perception is provided a little before the portion to which it relates is rendered can, for example, help the first user to adapt their explanations in advance (so as, for example, to anticipate difficulties in understanding). Thus, more detailed explanations than expected on certain points upstream of the rendering of the relevant portion can allow a second user with whom the multimedia element is shared to better understand this portion when it is rendered. In at least some embodiments, said providing is carried out subsequently to said portion of said multimedia element being rendered.

Such embodiments can allow a first user sharing the multimedia element to obtain feedback about the shared portion, so as to be able to react to this feedback, for example by providing additional explanations “in retrospect”.

In at least some embodiments, the method comprises detecting said audiovisual item in said portion of said multimedia element and said indication of perception is received in response to said audiovisual item being sent to said second devices.

In at least some embodiments, said detection of said audiovisual item and/or said sending of said audiovisual item are performed concurrently during said obtaining of said multimedia element.

In at least some embodiments, said method is carried out by an assistance service that is accessible to the first user after subscription.

According to another aspect, the present application relates to a method for reporting, to a first electronic device, a perception relating to a multimedia element, said method being carried out by a second electronic device and comprising:
obtaining at least part of at least one multimedia element;
providing said first electronic device with at least one indication of perception of one or more portions of said multimedia element by a second user of said second device, said indication of perception being obtained automatically by said second device.

Said indication of perception may, for example, be obtained without specific action from said second user.

In at least some embodiments, said providing of said indication of perception is carried out prior to said multimedia element being shared by a first user of said first device with said second user of said second device.

In at least some embodiments, said providing of said indication of perception is carried out when said multimedia element is synchronously shared by said first and second devices, prior to and/or at the time of said portion of said multimedia element being rendered.

In at least some embodiments, said audiovisual item is obtained by analyzing said multimedia element.

In at least some embodiments, said analysis of said multimedia element is performed concurrently at the time of said obtaining of said multimedia element.

In at least some embodiments, said portion of said multimedia element comprises at least one audiovisual item and said indication of perception is representative of the presence, or absence, of said audiovisual item in a knowledge base associated with said second user.

In at least some embodiments, this may be a base that groups words that are well known, or unfamiliar, to the second user.

In at least some embodiments, said portion of said multimedia element comprises at least one audiovisual item and said indication of perception takes into account a designation of said audiovisual item by means of a user interface of said second device.

In at least some embodiments, said method is carried out by an assistance service that is accessible after subscription by said second user of said second device.

Features that are presented separately in the present application in connection with some embodiments of at least one of the methods of the present application can be combined together into other embodiments of this method.

According to another aspect, the present application also relates to an electronic device suitable for carrying out at least one of the methods of the present application in any one of its embodiments.

For example, the present application thus relates to a first electronic device comprising at least one processor configured for assisting in sharing a multimedia element, said assistance comprising:
obtaining at least part of a multimedia element intended to be shared by a first user of said first electronic device with at least two second users of second electronic devices, said second users being distinct from said first user;
providing said first user with at least one piece of information representative of a perception of one or more portions of said multimedia element by at least one of said second users.

In some embodiments, said representative information may be information that does not allow said second users to be distinguished from one another, such as anonymized information.

For example, the present application thus relates to a second electronic device comprising at least one processor configured for reporting, to a first electronic device, a perception relating to a multimedia element, said reporting comprising:
obtaining at least part of at least one multimedia element;
providing said first electronic device with at least one indication of perception of one or more portions of said multimedia element by a second user of said second device, said indication of perception being obtained automatically by said second device.

According to another aspect, the present application also relates to a telecommunications system comprising at least one first electronic device suitable for carrying out the assistance method of the present application in any one of its embodiments and at least one second electronic device suitable for carrying out the perception reporting method of the present application in any one of its embodiments.

Thus, the present application relates, for example, to a telecommunications system comprising at least one first electronic device and at least one second electronic device, said at least one first electronic device comprising at least one processor configured for assisting

in sharing a multimedia element, said assistance comprising:
obtaining at least part of a multimedia element intended to be shared by a first user of said first electronic device with at least two second users of said second electronic device, said second users being distinct from said first user;
providing said first user with at least one piece of information representative of a perception of one or more portions of said multimedia element by at least one of said second users;
   and said at least one second electronic device comprising at least one processor configured to report, to said first electronic device, a perception relating to said multimedia element, said reporting comprising:
obtaining at least part of said at least one multimedia element;
providing said first electronic device with at least one indication of perception of one or more portions of said multimedia element by a second user of said second device, said indication of perception being obtained automatically by said second device.

In some embodiments, said representative information may be information that does not allow said second users to be distinguished from one another, such as anonymized information.

The present application also relates to a computer program comprising instructions for carrying out at least one embodiment of at least one of the above methods when the program is executed by a processor, and to a storage (or information) medium that can be read by an electronic device and that stores the computer program.

For example, the present application thus relates to a computer program comprising instructions for carrying out, when the program is executed by a processor of a first electronic device, a method for assisting in sharing a multimedia element, said assistance comprising:
obtaining at least part of a multimedia element intended to be shared by a first user of said first electronic device with at least two second users of a second electronic device, said second users being distinct from said first user;
providing said first user with at least one piece of information representative of a perception of one or more portions of said multimedia element by at least one of said second users.

In some embodiments, said representative information may be information that does not allow said second users to be distinguished from one another, such as anonymized information.

For example, the present application thus also relates to a computer program comprising instructions for carrying out, when the program is executed by a processor of a second electronic device, a method for reporting, to a first electronic device, a perception relating to a multimedia element, said method comprising:
obtaining at least part of at least one multimedia element;
providing said first electronic device with at least one indication of perception of one or more portions of said multimedia element by a second user of said second device, said indication of perception being obtained automatically by said second device.

For example, the present application also relates to an information medium that can be read by a processor of a first electronic device and that stores a computer program comprising instructions for carrying out, when the program is executed by the processor, a method for assisting in sharing a multimedia element, said assistance comprising:
obtaining at least part of a multimedia element intended to be shared by a first user of said first electronic device with at least two second users of a second electronic device, said second users being distinct from said first user;
providing said first user with at least one piece of information representative of a perception of one or more portions of said multimedia element by at least one of said second users.

In some embodiments, said representative information may be information that does not allow said second users to be distinguished from one another, such as anonymized information.

The present application also relates, for example, to a storage medium that can be read by a processor of a second electronic device and that stores a computer program comprising instructions for carrying out, when the program is executed by the processor, a method for reporting, to a first electronic device, a perception relating to a multimedia element, said method being carried out by a second electronic device and comprising:
obtaining at least part of at least one multimedia element;
providing said first electronic device with at least one indication of perception of one or more portions of said multimedia element by a second user of said second device, said indication of perception being obtained automatically by said second device.

The aforementioned programs can use any programming language and can be in the form of source code, object code or intermediate code between source code and object code, such as in a partially compiled form, or in any other desirable form.

The information (or storage) media mentioned in the present application can be any entity or device capable of storing the program. For example, a medium can include a storage means, such as a ROM, for example a CD-ROM or a microelectronic circuit ROM, or even a magnetic recording means.

Such a storage means can be, for example, a hard disk, a flash memory, etc.

Moreover, an information medium can be a transmissible medium such as an electrical or optical signal, which can be routed via an electrical or optical cable, by radio or by other means. A program according to an aspect of the present disclosure can in particular be downloaded from an Internet-type network.

Alternatively, an information (or storage) medium can be an integrated circuit incorporating a program, the circuit being suited to executing or being used to execute any one of the embodiments of at least one of the methods that is the subject matter of the present patent application.

In general, obtaining an information element is understood in the present application to mean, for example, receiving that information element from a communication network, and/or acquiring that information element (via, for example, user interface elements and/or sensors), and/or creating that information element by various processing means, such as by copying, and/or encoding, and/or decoding, and/or transforming, etc., and/or accessing that information element from a local or remote storage medium accessible to at least one device carrying out at least part of that obtaining.

In general, providing an information element is understood in the present application to mean, for example, transmitting that information element (perhaps preceded by copying, transforming and/or encoding) over a communication network, rendering that information element via output user interface elements, and/or storing that information element on a local or remote storage medium accessible to at least one device carrying out at least part of that providing.

### 5. BRIEF DESCRIPTION OF THE DRAWINGS

Other features and advantages present disclosure will become more clearly apparent upon reading the following description of particular embodiments, which are given by way of mere illustrative and non-limiting examples, and the appended drawings, among which:

FIG. 1 shows a simplified view of a system, cited by way of example, in which at least some embodiments of the sharing assistance and/or perception reporting methods of the present application can be implemented;

FIG. 2 shows a simplified view of a device suitable for carrying out at least some embodiments of the obtaining and/or reporting method of the present application;

FIG. 3A shows an overview of the sharing assistance method of the present application, in some of its embodiments;

FIG. 3B shows, in more detail than FIG. 3A, the sharing assistance method of the present application, in some of its embodiments;

FIG. 3C shows, in more detail than FIG. 3A, the sharing assistance method of the present application, in some of its embodiments;

FIG. 4A shows an overview of the perception reporting method of the present application, in some of its embodiments;

FIG. 4B shows, in more detail than FIG. 4A, the perception reporting method of the present application, in some of its embodiments;

FIG. 4C shows, in more detail than FIG. 4A, the perception reporting method of the present application, in some of its embodiments;

FIG. 5 shows an overview of a timing diagram when the sharing assistance and perception reporting methods of the present application, in some of their embodiments, are carried out jointly.

### 6. DESCRIPTION OF THE EMBODIMENTS

An exemplary aspect of the present application is to help a first user, the producer or presenter of a multimedia element (for example an audiovisual content or stream) to obtain feedback about this multimedia element. The feedback may relate to the perception of the multimedia element by at least one of the persons with whom the first user wishes to share, or is in the process of sharing, this multimedia element. These persons are also called, in the application, (potential or actual) consumer(s) of the multimedia element and “second” users (to distinguish them from the first user sharing the multimedia element). This feedback can, in particular, be used by the first user to assess the relevance of the multimedia element to be shared with regard to the second users.

The feedback may, for example, be provided to the first user in the form of information representative of perception, for example forming a summary of at least some of the individual reports from the second users.

Depending on the embodiments, the feedback can be provided to the first user in real time (while they are constructing or viewing a multimedia element for future sharing, or while they are sharing it) or in non-real time (after that constructing, viewing or sharing).

Depending on the communication tools and multimedia element that are used, sharing can be performed “synchronously” (for example during a teleconference) between the first and second users or asynchronously (for example by sharing a text file by e-mail). For example, this may be simple provision, by the first user, of this multimedia element for the attention of this or these second users.

Such a solution may in particular be particularly advantageous in situations where the first user does not know (or does not really know) the second users.

For example, during a videoconference, a participant sharing a document (for example a textual presentation) with the other participants in the videoconference and commenting on it (for example orally) can obtain in real time, courtesy of the solution of the present application, feedback about the perception of certain passages of this document by these other participants. This may include, for example, information relating to their level of understanding of, their level of agreement or disagreement with, and/or their level of interest in, certain passages of the document.

The solution allows, in particular, the presenter (first user) to be informed of the terminology in the document that is little known or unfamiliar to their audience (second users), so as to allow the presenter to adapt what they are saying accordingly (for example to explain acronyms, reformulate a sentence, etc.).

Similarly, the solution can also allow the presenter to obtain feedback about some of their comments, so that, for example, they can reiterate or reformulate an explanation that is little understood by some participants.

Such a solution can, in particular, be used when the commentator is unable to see the faces of the participants (and therefore instinctively assess their reactions to what he or she is saying).

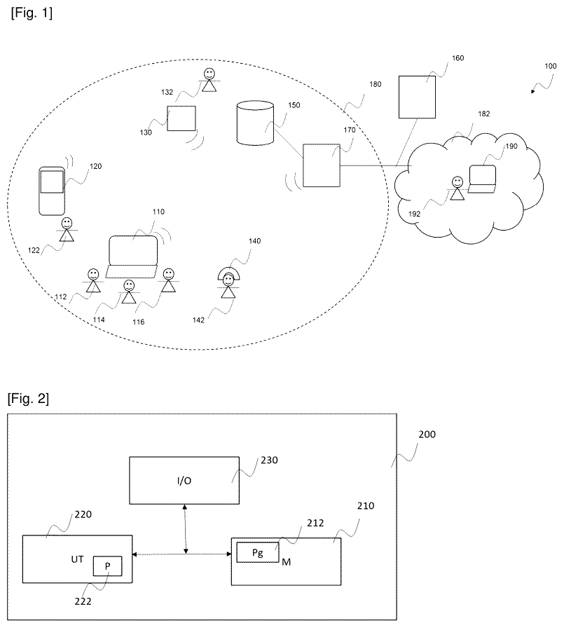

The present application will now be described in more detail with reference to FIG. 1. FIG. 1 shows a telecommunications system 100 in which some embodiments of the present disclosure can be used. The system 100 comprises one or more electronic devices, at least some of which are able to communicate with one another via one or more, optionally interconnected, communication networks 180, 182 (via, for example, an interconnection device 170 (also referred to as a gateway), such as a LAN (Local Area Network) and/or a WAN (Wide Area Network). Examples of networks can include a business or domestic LAN and/or an Internet or cellular WAN, GSM (Global System for Mobile Communications), UMTS (Universal Mobile Telecommunications System), Wi-Fi (wireless), etc. The electronic devices of the system 100 may be diverse: they may be, for example, terminals 110, 120, 130, 190 (such as a laptop computer, a smartphone, a smart TV and/or a tablet) as illustrated in FIG. 1, mixed or virtual augmented reality headsets 140, smart objects, and/or server(s), for example an application server 160, in particular a teleconferencing application (such as a videoconferencing server), a storage device 150. The system may also comprise management and/or network interconnection elements (not shown). These electronic devices may be associated with at least one user 112, 114, 116, 122, 132, 142, 192 (for example by means of a user account accessible by login), some of the electronic devices 120 being able to be associated with the same user 122, some of the electronic devices 110 being able to be shared by multiple users 112, 114, 116 (these devices 110 being, for example, capable of being used by different users at different times). At least some of the devices of the system 100 are likely to be used by their respective users for sharing (within the same device or between devices) at least one multimedia element. This multimedia element may be diverse. For example, it may have at least one component of the audio, image, video and/or textual type or a combination of such components. This/these may be content already stored in memory in its entirety (such as a slideshow), or an element (stream) that is being constructed (or broadcast).

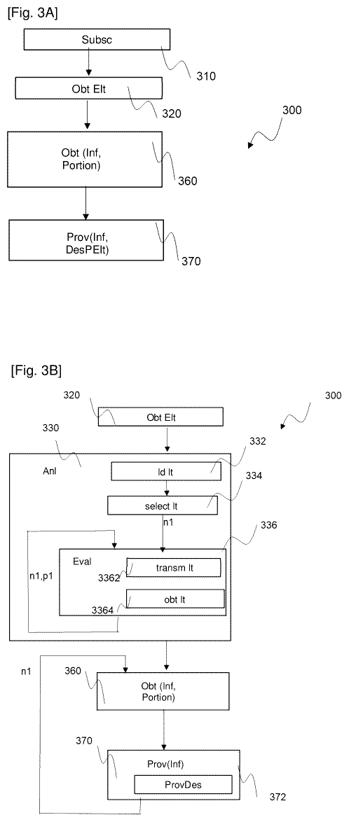

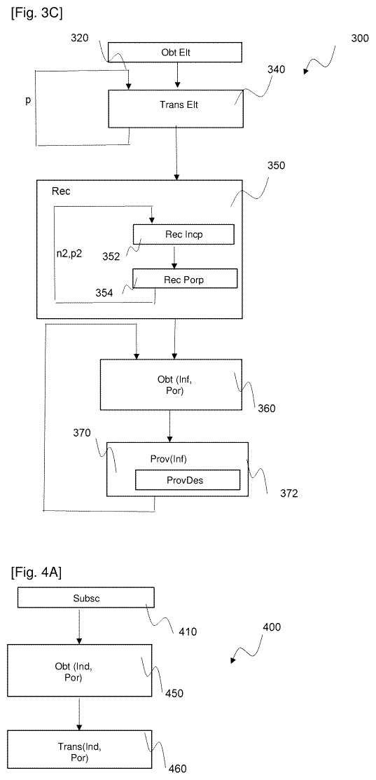

FIG. 2 illustrates a simplified structure of an electronic device 200 of the system 100 that is suitable for applying the principles of the present application. Depending on the embodiments, this may be a server (for example the server 160 in FIG. 1), and/or a terminal (for example one of the terminals 110, 120, 130, 140 and 190 in FIG. 1). The device 200 in particular comprises at least one memory M 210. The device 200 may in particular comprise a buffer memory, a volatile memory, for example a RAM (Random Access Memory), and/or a non-volatile memory, for example a ROM (Read-Only Memory). The device 200 may also comprise a processing unit UT 220, for example equipped with at least one processor P 222, and controlled by a computer program PG 212 stored in the memory M 210. On initialization, the code instructions of the computer program PG are, for example, loaded into a RAM before being executed by the processor P. Said at least one processor P 222 of the processing unit UT 220 can, in particular, carry out, individually or collectively, any one of the embodiments of at least one of the assistance and/or reporting methods of the present application (in particular as described with reference to FIGS. 3A and 3B, respectively), according to the instructions of the computer program PG. The device may also comprise, or be coupled to, at least one I/O (input/output) module 230, such as a communication module, allowing, for example, the device 200 to communicate with other devices of the system 100, via wired or wireless communication interfaces, and/or such as a module for interfacing with a user of the device (also more simply referred to as “user interface” in this application).

A user interface of the device is understood to mean, for example, an interface integrated in the device 200, or part of a third-party device coupled to this device by wired or wireless communication means. For example, this can be a secondary screen of the device, a camera (for example for acquiring gestural commands from an operator) or loudspeakers connected to the device by means of wireless technology.

A user interface may, in particular, be an “output” user interface suitable for rendering (or controlling the rendering of) an output element of a computer application used by the device 200, for example an application running at least in part on the device 200 or an “online” application running at least in part remotely, for example on the server 160 of the system 100. Examples of an output user interface of the device include one or more screens, in particular at least one graphics screen (for example a touchscreen), one or more loudspeakers, a smart headset (in particular a mixed or virtual augmented reality headset). Rendering is understood herein to mean rendering (or output) over at least one user interface, in any form, for example comprising textual, audio, image and/or video components, or a combination of such components.

Moreover, a user interface may be a user interface, called an “input” user interface, suitable for acquiring an action or a reaction of a user of the device 200 (in particular an action such as a command, or a reaction such as a movement, a physical or verbal expression, etc.). This may, in particular, be an action or a reaction in connection with an item rendered by the device 200 (such as a reaction to this item), and/or a command to be transmitted to a computer application used by the device 200, for example an application running at least in part on the device 200 or an “online” application running at least in part remotely, for example on the server 160 of the system 100. Examples of an input user interface of the device 200 include one or more sensors for detecting a movement (for example an eye movement of a user) such as one or more motion sensors, one or more eye-tracking devices, one or more cameras, sensors for acquiring sound, such as a microphone, a means of acquiring a command (for example one or more keys, a keyboard, a button, a pointing device (mouse), an actuator of a touchscreen) etc.

The device may also comprise image analyzers capable of interpreting a user's body language or of identifying a user in a visual element (an image, a video) representing that user.

Said at least one microprocessor of the device 200 may, in particular, be suited to carrying out at least one of the methods of the present application.

Thus, in some embodiments, said at least one microprocessor of the device 200 may, in particular, be suited to carrying out a method for assisting in sharing a multimedia element, said method comprising:
obtaining at least part of a multimedia element intended to be shared by a first user of said first electronic device with at least two second users of second electronic devices, said second users being distinct from said first user;
providing said first user with at least one piece of information representative of a perception of one or more portions of said multimedia element by at least one of said second users, said representative information being information that does not allow said second users to be distinguished from one another (such as anonymized information).

In some embodiments, said at least one microprocessor of the device 200 may, in particular, be suited to carrying out a method for reporting, to a first electronic device (different or mistaken for the device 200), a perception relating to a multimedia element, said reporting comprising:
obtaining at least part of at least one multimedia element;
providing said first electronic device with at least one indication of perception of one or more portions of said multimedia element by a second user of said second device, said indication of perception being obtained automatically by said second device.

To this end, the device 200 may comprise, for example, inter alia, an analysis module for analyzing the multimedia element, a knowledge management module, and/or a transfer module, and a module for processing reports relating to the second users with whom the element is shared.

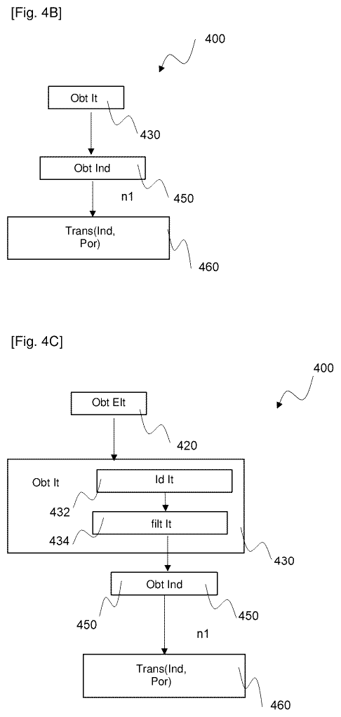

The analysis module may, for example, be responsible for the analysis of the multimedia element that is performed by the device 200 described in particular in connection with FIGS. 3B and 4C. The knowledge management module may, for example, be responsible for searching knowledge bases described below in particular in connection with FIGS. 3B and 4C.

The transfer module may, for example, be responsible for data transmissions from or to the device 200 for carrying out at least one of the methods of the present application. Optionally, the device may also comprise conversion modules, such as text-to-voice or conversely voice-to-text converters.

It should be noted that, in some embodiments, the device may be suitable both for carrying out the assistance method and for the reporting method, whether at different times or simultaneously. In other embodiments, on the other hand, the methods of the present application can be carried out by different devices.

Some of the above input-output modules are optional and may therefore be absent from the device 200 in some embodiments, In particular, although the present application is sometimes described with reference to a first device communicating with at least one second device of the system 100, at least one of the assistance and perception reporting methods can also be carried out locally by a device (for example at different times), some of the communication modules then being able to be absent (or inactive).

On the other hand, in some of its embodiments, the at least one of the assistance or reporting methods can be carried out in a manner distributed between at least two devices 110, 120, 130, 140, 150, 160, 170, 190 of the system 100.

For example, one or other of the methods can be executed in part on a terminal and a server, and can use at least one knowledge base dedicated to a user of another terminal and accessible to this server (for example via a local area network).

The term “module” or the term “component” or “element” of the device is understood herein to mean a hardware element, in particular a wired hardware element, or a software element, or a combination of at least one hardware element and at least one software element. The methods according to the present disclosure can therefore be carried out in various ways, in particular in wired form and/or in software form.

Some embodiments of the assistance method 300 of the present application will now be presented in greater detail in connection with FIGS. 3A to 3C (some embodiments of the reporting method of the present application are then described in connection with FIGS. 4A to 4C).

The method 300 may, for example, be implemented by the electronic device 200 illustrated in FIG. 2. This may, in particular, be a first device (such as a terminal), a user of which wishes to share a multimedia element with other users of this electronic device or other electronic devices, or else a server of the system 100 that communicates with such a first device to provide this first user with an assistance service.

As already explained, for the sake of simplicity the application terms the user wishing to share a multimedia element the “first” user and the “other” users “second” users.

As illustrated in FIG. 3A, the assistance method 300 may comprise obtaining 320, at least part of, a multimedia element to be shared. In some embodiments, this may be an already constructed element (for example a multimedia content) that is accessible to the first device locally or remotely). This multimedia element may, for example, have been constructed beforehand by a user for whom the assistance method is carried out, or by a third-party user. For example, it may be a multimedia element available off the shelf (such as a multimedia element that belongs to a content library). In such embodiments, the assistance method can then allow an a posteriori assessment of the multimedia element with regard to at least some of the expected consumers of this multimedia element (before it is distributed to these consumers or when it is distributed).

In some embodiments, this may be a multimedia element under construction that is obtained in part and on which the assistance method can be carried out concurrently according to the “target” consumers of this multimedia element. For example, this may be an audiovisual stream that is being acquired and that is broadcast as it is acquired. For example, it may be an audiovisual stream corresponding to what is being said (audio or video) by a participant in a videoconference.

The multimedia element may, in particular, be generated on the device 200 (in particular when it is a terminal-type electronic device) or received by the device 200 (for example when the device 200 is a server).

As illustrated in FIG. 3A, the assistance method may comprise obtaining 360 at least one piece of information representative of a perception of at least one portion of the multimedia element by at least one of the second users (and target consumers). This information representative of a perception is also referred to as summary information below for the sake of simplicity.

In the example of FIG. 3A, the assistance method may further comprise providing 370 this summary information. Providing is understood to mean processing comprising rendering on an output user interface of the device 200, and/or sending to another device, and/or storing on and/or from the device 200. Optionally, the providing 370 of the summary information may be accompanied by a designation of at least one portion of the multimedia element.

According to a first example, when the device 200 is a server (such as the server 160 of FIG. 1), the providing may comprise sending to the first device of the first user wishing to share the multimedia element).

According to a second example, when the device 200 is the device of the first user wishing to share the multimedia element, the providing of the summary information may comprise rendering the summary information (or an information element taking this summary information into account) on an output user interface of the device 200.

When the providing of the summary information comprises rendering, this rendering may, for example, be in sync with the multimedia element (so as, for example, to simultaneously “render” a page of a slideshow and the summary information relating to the content of that page).

According to a third example, the providing may comprise storing the summary information (for example in a storage device such as the device 150 of FIG. 1) for subsequent use. In particular, the summary information may be stored together with the multimedia element (for example in the form of metadata). Thus, when the summary information is provided before the multimedia element is shared, the summary information may, in some embodiments, be stored together with the multimedia element in order to be rendered on the device of a “first” user sharing this multimedia element when this multimedia element is shared (for example in sync with the currently shared part of the multimedia element) so as, for example, to assist this “first” user when they present this multimedia element at the time of its being shared. The summary information provided to the first user, courtesy of the assistance method of the present application, can thus be used, for example, to adapt the broadcasting of the multimedia element accordingly (for example by broadcasting a second element that is complementary to this multimedia element (such as an oral or textual comment, for example), as an accompaniment to the broadcasting of the multimedia element).

The summary information provided to the first user can also be used, in some embodiments where the multimedia element is modifiable, to modify the multimedia element accordingly, prior to its being broadcast, for better adaptation to the “target” consumers of this multimedia element.

As explained above, providing summary information is understood to mean, in particular, rendering the summary information on an output user interface of the first device, and/or storing the summary information for subsequent use of this information, for example together with the multimedia element (for example in the form of metadata).

Thus, when the summary information is provided before the multimedia element is broadcast, the summary information may, in some embodiments, be stored together with the multimedia element in order to be rendered on the first device when the multimedia element is broadcast (for example in sync with the portion of the multimedia element) so as, for example, to assist a presenter of this multimedia element using the first device.

It should be noted that the assistance method can be carried out, depending on the embodiments, systematically or on subscription 310 to a service (and perhaps manual activation (not illustrated) of this service by the first user wishing to share a multimedia element), this subscription 310 and/or this possible activation being able to be carried out beforehand or at the time of this sharing.

For example, the assistance method can be carried out concurrently when a multimedia element is rendered (periodically or according to the variations in the rendering of the multimedia element (for example on each page turn when the multimedia element is a slideshow)). According to another example, it can be carried out at the request of the first user (for example by means of the user interface of the device 200).

The obtaining of summary information will now be presented in greater detail with reference to FIG. 3B in embodiments in which the assistance method carries out an at least partial analysis 330 of the multimedia element 320 obtained at least in part by the device 200, prior to or at the time of this multimedia element being shared. (It should be noted that this analysis may be optional in other embodiments, as explained below).

For the sake of simplicity, the (optional) subscription to the assistance service is not illustrated in FIG. 3B.

As illustrated in FIG. 3B, in some embodiments, an at least partial analysis 330 of the multimedia element can be carried out so as to allow identification 332 of items of that multimedia element that require a priori assessment 336 of the perception of that multimedia element by second users who are “target” consumers (p1 second users in the example of FIG. 3A, p1 being a natural integer greater than 1). These items may, for example, be items extracted from the multimedia element (for example using language analysis techniques). For example, they may be nominated entities, keywords, special static (for example a logo) or dynamic (for example a video) graphical elements, acronyms, abbreviations, mathematical formulae, etc.

Optionally, before or at the time of the assessment 336, the method may comprise selecting 334 items to be assessed from among the identified items. For example; the selected items may comprise items that are considered, for example by means of configuration or annotation of the multimedia element, to be important to the author and/or owner of the multimedia element, or the first user. Complementarily (alternatively or cumulatively), the selected items may comprise items that are considered a priori to be likely to be unfamiliar to at least one of the consumers of the multimedia element. Selection may, for example, comprise searching a knowledge base accessible to the device 200, such as a general knowledge base for the system 100 (a dictionary), and/or searching a base that lists audiovisual items unfamiliar to the user wishing to share the multimedia element (or conversely audiovisual items that are well known to this user).

The identified (and optionally selected) items can, for example, be assessed 336 by searching at least one knowledge base accessible to the device 200, such as at least one knowledge base that lists audiovisual items well known (or unfamiliar) to at least one of the second users who are target consumers of the multimedia element (such as bases that are each specifically associated with one of the target consumers, or a base that is associated with multiple consumers having common characteristics, such as belonging to the same organization, or similar socio-professional characteristics). In particular, this may be a knowledge base that is locally accessible to the device 200 (for example when the latter is a server implementing the assistance method in a “centralized” manner), or else (a) base(s) that are remotely accessible, for example on a remote storage device, or via the devices used by these second users (for example by interrogating these devices). In the example illustrated in FIG. 3B, the assessment concerns n1 items, n1 being a natural integer not less than 1.

Assessing 336 the identified items may optionally comprise transmitting 3362 at least one item to be assessed to at least one third-party device. This third-party device may, for example, be a server (such as the server 160 in FIG. 1), a storage device (such as the device 150 in FIG. 1, or one of the devices of the “second” users with whom the multimedia element is to be shared (for example at least terminals 110, 120, 130, 140, 190 in FIG. 1)). Assessing 336 the identified items allows indications of perception of these items to be obtained 3364 for at least some of the second users according to the results of the locally or remotely performed searches, each of these indications of perception being able to be specific to one of these second users, for example. Obtaining 3364 the indications of perception may optionally comprise receiving these indications of perception from a third-party device to which at least one item to be assessed has been transmitted. The indications of perception may vary depending on the embodiments. In particular, in some embodiments, they may be a Boolean value (for example indicating the relevant user's knowledge or lack of knowledge of the item). In some embodiments, they may be a numerical indicator taking a value that belongs to a discrete set of at least 3 distinct values. In some embodiments, they may be a numerical indicator that belongs to a numerical range defined, for example, by (for example configurable) lower and upper limits representative of the relevant user's knowledge and lack of knowledge, respectively, of the item (or vice versa), the proximity of the perception indication to these limits being representative of the second user's “perceived” knowledge.

It should be noted that, depending on the embodiments, indications of perception can be obtained for all the second users who are the “target” of the sharing, or only for some of them (for example those who have accepted this reporting of perception information, for example by subscribing to a service for reporting indications of perception, which is complementary to the assistance service, and/or, optionally, by having, in addition, activated this service).

The method 300 may also comprise obtaining 360 at least one piece of summary information from at least some of the “individual” indications of perception obtained 3364. For example, summary information may correspond to a summary of the perception of one of the identified items by all the second users (or by a subset of these second users), such as a number or percentage of second users who are familiar with this item. One example of rendering may be a textual label such as “Item X known by k % of the recipients of the sharing (or alternatively by p recipients among the n recipients).

Another example of rendering may be a textual label such as “Item X1: known by p1/n recipients” (where n is the total number of recipients).

According to another, third example, the summary information relating to portions of the multimedia element that are shared synchronously can be rendered jointly (for example joint rendering of the summary information relating to items on the same page of a paginated multimedia element).

Obviously, depending on the embodiments and on the portion and multimedia element under consideration, the number of pieces of summary information provided and/or the number of pieces of summary information provided simultaneously may vary.

It should be noted that the providing 370 of summary information relating to an item may optionally comprise, in addition, a designation 372 of at least one portion of the multimedia element. In the example of FIG. 3B, this may, in particular, be a portion of the multimedia element in which this element has been identified. This designation can vary depending on the embodiments. It may comprise, for example, a designation of a page number of the relevant multimedia element if it is a paginated document, and/or a designation of a position of the item to which the summary information relates in the relevant portion, . . . ).

If the providing comprises rendering the summary information, the method may comprise jointly rendering an indication relating to the designated portion, such as, for example a label, graphical emphasis (such as highlighting, a particular color associated with the portion in a heat map rendered jointly with the multimedia element, etc.), etc. Depending on the embodiments, the rendering of the information can be in sync with the rendering of the portion of the multimedia element containing the item to which the summary information relates or can be performed concurrently (even if the item to which the summary information relates is no longer rendered). Such an embodiment can, for example, help a presenter to provide additions relating to this item “in retrospect”.

Other embodiments, in which the method comprises transmitting 340 the multimedia element, when or after it is obtained 320, without prior analysis of this multimedia element by the device 200, will now be presented in connection with FIG. 3C. For example, this may involve sharing a multimedia element during a videoconference, with synchronous consumption of this multimedia element by the second users. It may also involve sharing a multimedia content (for example by e-mail) for subsequent consumption of this content by one or more of the second users. In such embodiments, the analysis may be performed by a third-party device (such as the server 160 and/or the devices of the second users). For the sake of simplicity, the (optional) subscription to the assistance service is not illustrated in FIG. 3C.

As illustrated in FIG. 3C, the method may comprise transmitting 340 the multimedia element obtained at least in part to at least one third-party device (such as the server 160 and/or the devices of the second users). Thus, FIG. 3C shows a transmission to p third-party devices (p being an integer not less than 1). As illustrated, the method 300 comprises receiving 350, from at least one of these third-party devices, at least one indication of perception (receiving 352) by at least some of the second users, relating to at least one portion of the multimedia element transmitted (for example relating to at least one item contained in that portion). Thus, FIG. 3C shows p2 indications of perception being received (p2 being an integer not less than 1). These indications of perception may be similar to the indications of perception already described in connection with FIG. 3B.

As illustrated in FIG. 3C, the method may optionally comprise receiving a designation (receiving 354) of at least one portion of the multimedia element together with at least one indication of perception received 352, this indication of perception then relating to that portion. For example, this may involve concomitantly receiving a designation of a portion of the multimedia element comprising an item (as described above) to which the received indication of perception relates. Depending on the embodiments, the designation information and the indication of perception may be received 350, 352, 354 jointly or sequentially. The method 300 may further comprise obtaining 360 at least one piece of summary information from the designations of portions received 352 and the “individual” indications of perception received 354. According to a first example, summary information may correspond to a summary of the perception indications s received for the same portion of the multimedia element (such as, for example, an audiovisual item as introduced above). According to a second example, summary information may correspond to a summary of the received perception indications associated with portions having at least one common part. The method 300 may further comprise providing 370 the summary information obtained 360. As explained above, this providing may optionally be accompanied by a designation 372 of at least one portion of the multimedia element. In the embodiment illustrated in FIG. 3C, this may be at least one portion associated with at least one perception indication from which the summary information has been obtained. For example, the designated portion may be a portion associated with all the indications of perception from which the summary information has been obtained, i.e. an “intersection” of the portions associated with each of the indications of perception from which the summary information has been obtained. According to another example, the designated portion may be a portion uniting all the portions associated with indications of perception from which the summary information has been obtained, i.e. a “union” (or aggregation) of the portions associated with each of the indications of perception from which the summary information has been obtained. Some embodiments of the reporting method 400 of the present application will now be presented in greater detail in connection with FIGS. 4A to 4C. The reporting method, in the embodiments described with reference to FIG. 4A (or 4B, or 4C) can be used in particular to process data from the assistance method of FIG. 3A (or 4B, or 4C).

For example, the reporting method can be carried out each time data (multimedia element, item..) from the assistance method are received. It can also be used systematically when a shared multimedia element is obtained (periodically or as the multimedia element is rendered), or upon receipt of a specific request from the device sharing this multimedia element or from the second user (for example by means of the user interface of the device 200).

The method 400 may, for example, be implemented by the electronic device 200 illustrated in FIG. 2. In particular, this may be a device (called a “second” device in the present application), a user of which (called a “second” user in the present application) is one of the persons with whom a user of a first device wishes to share, or actually shares, at least part of a multimedia element. The method is carried out to report at least one indication of perception, to this second user, relating to one or more portions of this multimedia element. Depending on the embodiments, this may be an “a priori” perception to this second user or an actual perception. The second device may be a server or a communication terminal, for example.

As illustrated in FIG. 4A, the reporting method 400 may comprise obtaining 450 at least one indication of perception, to this second user, relating to one or more portions of this multimedia element. This may be, for example, at least one indication of perception as described above in connection with one of FIGS. 3A, 3B and/or 3C and/or below in connection with FIG. 4B or 4C.

The reporting method 400 may further comprise transmitting 460 at least some of the indications of perception obtained to a device transmitting the multimedia element (for example the device of the first user or an application server). This transmission may be conditional (for example, in some embodiments, only some indications of perception obtained may be transmitted (for example only indications of perception obtained that are representative of the second user's weak knowledge or understanding may be transmitted)).

It should be noted that the reporting method 400 can be carried out, depending on the embodiments, systematically or on subscription 410 to a service (and perhaps manual activation of this service by the second user).

The obtaining of indications of perception will now be presented in greater detail with reference to FIG. 4B, in (for example “at least partially centralized”) embodiments in which the reporting method 400 comprises obtaining 430 (for example receiving) at least one audiovisual item from the multimedia element (as already described with reference to FIG. 3B) that requires assessment of the perception for this second user.

For the sake of simplicity, the (optional) subscription to the service for reporting (an) indication(s) of perception is not illustrated in FIG. 4B.

The reporting method 400 can thus comprise obtaining 450 at least one indication of the perception, by the second user, of the item obtained.

The indication of perception obtained for an item may depend on an assessment of the relevance of that item to the second user. It may, for example, take account of the results of searches performed on that item in knowledge bases. For example, the method may comprise searching at least one knowledge base accessible to the device 200, such as at least one knowledge base that lists audiovisual items known (or unfamiliar) to the second user (the target consumer of the multimedia element). For example, these may be bases associated specifically with the second user or shared between the second user and other consumers of multimedia elements, these other consumers having characteristics in common with the second user (as described with reference to FIG. 3A). In particular, they may be a knowledge base that is locally or remotely accessible to the device 200.

The indication of perception may also correspond to a level of attention paid by the second user to the rendering of that item on the device 200 (for example attention paid to a screen area where that item appears). This level of attention can, for example, be measured by a gaze tracking module installed on the device 200 (for example according to the time spent looking at that item).

The indication of perception may also correspond to an interpretation of a second user's body language (for example facial expression) or movement when the item is rendered by the device 200. Such body language or such a gesture can, for example, be picked up by a camera coupled to a gaze tracking module of the device 200. For example; the acquisition of a “frown” could be interpreted as the second user's poor knowledge of the item under consideration.

As illustrated, the method may also comprise transmitting 460 the indication of perception to the device transmitting the multimedia element (as described in connection with FIG. 4A). Other embodiments, in which the reporting method comprises obtaining 420 (for example receiving) at least part of the multimedia element, will now be presented in connection with FIG. 4C. For example, this may be a multimedia element that is being shared or intended for later sharing with the second user.

For the sake of simplicity, the (optional) subscription to the service for reporting (an) indication(s) of perception is not illustrated in FIG. 4C.

The reporting method 400 may further comprise obtaining 450 at least one indication of the perception, by the second user, of at least one portion of the multimedia element received and obtaining a designation of this portion.

In some embodiments, similarly to what has been described in connection with FIG. 3B, the method may comprise an analysis 430 of the multimedia element so as to allow identification 432 of items of that multimedia element that require assessment of the (a priori or actual) perception by the second user. Optionally, the method may comprise filtering 434 the items to be assessed among the identified items. For example, the filtering can be used to keep, for assessment, only items that are considered, for example by means of configuration or annotation of the multimedia element, to be important to the author and/or owner of the multimedia element, or the first user.

The method 400 may comprise obtaining 450 an indication of perception of the identified

(and optionally selected) items. The obtaining 450 of an indication of perception for an item may be similar to what has been described in connection with FIG. 4B.

Thus, similarly to what is described above for FIG. 4B, an indication of perception relating to an identified and/or selected item may depend on the result(s) of search(s) performed on that item in knowledge bases, or may correspond to a level of attention paid by the second user to the rendering of that item on the device 200 or to the user's body language or gesture when this portion is rendered.

Optionally, the method may comprise obtaining a designation of at least one portion of the multimedia element to which at least one indication of perception obtained relates. For example, this may be a designation of a portion of the multimedia element comprising at least one item (from the analysis described above) to which at least one indication of perception obtained 430 relates.

In some embodiments, an indication of perception can be obtained (for example in a manner complementary to the analysis described above) by way of a manual action by the second user. For example, a manual action by the second user by means of a pointing device of the device 200 can allow designation of a portion with which the second user can manually

associate an indication of perception (representative, for example, of the second user's good or weak knowledge of at least one term in that portion, or of the second user's good or poor understanding of that portion) or with which an indication of perception can be automatically associated (for example by means of configuration). Thus, in some embodiments, the designation, for example using a mouse, of an item of a multimedia element rendered on the device 200 can be automatically associated with the second user's poor knowledge, or poor understanding, of that item. Such an embodiment can allow a user consuming the multimedia element to indicate their poor understanding of an item to the presenter of that multimedia element in a very simple way (in particular during synchronous sharing).

As illustrated, the method may comprise transmitting 460 the indication of perception to the first device and, optionally, transmitting 462 the designation obtained for a portion.

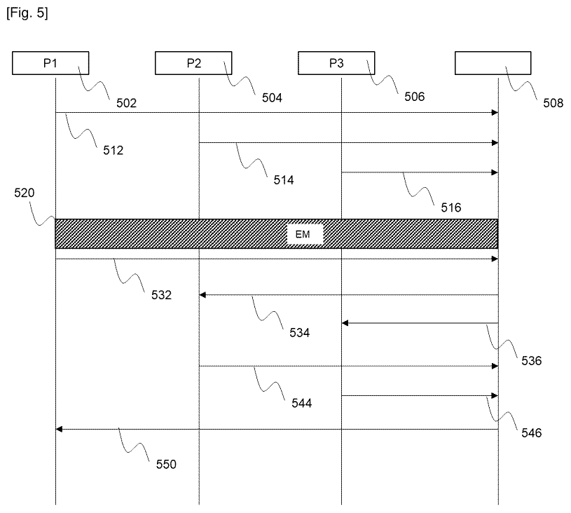

A use case will now be presented in connection with FIG. 5.

FIG. 5 illustrates, in the form of a timing diagram, some exchanges and processing performed between participants in a teleconference, a first participant P1 wishing to share a multimedia element (in this example a slideshow) with second participants P2, P3. The exchanges take place between a first device 502 of the first participant P1 and second devices 504, 506 of these second participants, via (optionally) a dedicated server 508. As illustrated in FIG. 5, before the multimedia element is shared 520, the first device subscribes 512 to a sharing assistance service on a dedicated server 508 and each of the second devices 504, 506 subscribes 514, 516 to a complementary service for reporting an indication of perception on the dedicated server 508.

When sharing 520 the slideshow, the first participant P1 activates the assistance service. The first device 502 transmits 532 the relevant page to the server 508, which analyzes the page received and identifies items to be assessed, which it transmits 534, 536 to the devices 504 and 506. These each access databases that are local to these devices and representative of the knowledge of each of the users P2 and P3, obtain indications of perception (here levels of knowledge) of these items accordingly and in turn transmit them 544, 546 to the server 508, which deduces therefrom summary information relating to the levels of knowledge about the items that are present on the received page. The server transmits 550 this summary information to the first device. This summary information is rendered by the first device 502 at the same time as the page of the relevant slideshow so as to allow the participant P1 to adapt the oral presentation of the slideshow accordingly. It should be noted that in the example illustrated in FIG. 5 the summary information is obtained at the request of the participant P1. Alternatively, the summary information can be obtained automatically, without any action by the user, the multimedia element being analyzed concurrently by the server.

The present application can be used in various fields, both professional and personal, for sharing multimedia elements with multiple recipients.

For example, it can be used to assess the perception of a multimedia element by a panel of users before that multimedia element is distributed more widely. In particular, it can be used to adapt a multimedia element according to the expected audience for that multimedia element or to adapt a presentation of that multimedia element according to that expected audience, without requiring the author of the multimedia element or a presenter of that multimedia element to have prior knowledge of that audience.

Although the present disclosure has been described with reference to one or more examples, workers skilled in the art will recognize that changes may be made in form and detail without departing from the scope of the disclosure and/or the appended claims.

1. A method being implemented by an electronic device and comprising:
obtaining at least part of a multimedia element intended to be shared by a first user of the first electronic device with at least two second users of second electronic devices, said second users being distinct from said first user; and
providing said first user with at least one piece of information representative of a perception by at least one of said second users of an audiovisual item detected in said multimedia element or comprised in a portion of said multimedia element designated by at least one of said second devices.

2. The method of claim 1, wherein said representative information takes into account said at least one second user's knowledge level of at least one audiovisual item present in said portion of said multimedia element.

3. The method of claim 2, wherein the method comprises detecting said audiovisual item in said portion of said multimedia element and wherein said indication of perception is received in response to said audiovisual item being sent to said second devices.

4. The method of claim 3, wherein said detecting said audiovisual item and/or a sending of said audiovisual item are performed concurrently during said obtaining of said multimedia element.

5. The method of claim 1 wherein said representative information takes into account at least one indication of perception received from at least one of said second devices via a communication interface of said first device.

6. The method of claim 1, wherein said providing is carried out prior to said multimedia element being shared.

7. The method of claim 1, wherein said providing of said representative information is carried out when said multimedia element is synchronously shared between said first and second devices, prior to and/or at the time of said portion of said multimedia element being rendered.

8. A reporting method for reporting, to a first electronic device, a perception relating to a multimedia element, said method being carried out by a second electronic device and comprising:
obtaining at least part of at least one multimedia element; and
providing said first electronic device with at least one indication of perception by said second user of at least one audiovisual item obtained by analyzing said multimedia element, said indication being obtained automatically by said second device.

9. The reporting method of claim 8, wherein said providing of said indication of perception is carried out when said multimedia element is synchronously shared between said first and second devices, prior to and/or at the time of said portion of said received multimedia element being rendered.

10. The reporting method of claim 9, wherein said audiovisual item is obtained by analyzing said multimedia element.

11. The reporting method of claim 10, wherein said analysis of said multimedia element is performed concurrently at the time of said obtaining of said multimedia element.

12. The reporting method of claim 8, wherein said portion of said multimedia element comprises at least one audiovisual item and wherein said indication of perception is representative of a presence, or absence, of said audiovisual item in a knowledge base associated with said second user.

13. The reporting method of claim 8, wherein said portion of said multimedia element comprises at least one audiovisual item and wherein said indication of perception takes into account a designation of said audiovisual item by using a user interface of said second device.

14. A telecommunications system comprising:
at least one first electronic device; and
at least one second electronic device,
said at least one first electronic device comprising at least one first processor configured to assist in sharing a multimedia element by:
obtaining at least part of a multimedia element intended to be shared by a first user of said first electronic device with at least two second users of said second electronic device, said second users being distinct from said first user; and
providing said first user with at least one piece of information representative of a perception by at least one of said second users of an audiovisual item detected in said multimedia element or comprised in a portion of said multimedia element designated by at least one of said second devices; and
said at least one second electronic device comprising at least one second processor configured to report, to said first electronic device, a perception relating to said multimedia element by:
obtaining at least part of said at least one multimedia element; and
providing said first electronic device with at least one indication of perception of at least one audiovisual item obtained by analyzing said multimedia element by a second user of said second device of at least one audiovisual item obtained by analyzing said multimedia element, said indication of perception being obtained automatically by said second device.

15. A first electronic device comprising at least one processor configured for carrying out the method of claim 1.

16. The first electronic device of claim 15, wherein said representative information takes into account said at least one second user's knowledge level of at least one audiovisual item present in said portion of said multimedia element.

17. The first electronic device of claim 15, wherein said providing is carried out prior to said multimedia element being shared.

18. The first electronic device of claim 15, wherein said providing of said representative information is carried out when said multimedia element is synchronously shared between said first and second devices, prior to and/or at the time of said portion of said multimedia element being rendered.

19. A second electronic device comprising at least one processor configured for carrying out the method of claim 8.

20. The second electronic device of claim 19, wherein said providing of said indication of perception is carried out when said multimedia element is synchronously shared between said first and second devices, prior to and/or at the time of said portion of said received multimedia element being rendered.
